(19) United States
(12) Patent Application Publication
(10) Pub. No.: US 2017/0091016 A1
(43) Pub. Date: Mar. 30, 2017

(54) CONTINUAL EXECUTION IN A COMPUTING SYSTEM

(71) Applicant: SAP Portals Israel Ltd, Ra'anana, IL (US)

(72) Inventors: YAN VULICH, Kiryat Ono, IL (US); ISAAC ELIASSI, Kfar Saba, IL (US)

(21) Appl. No.: 14/871,349

(22) Filed: Sep. 30, 2015

(51) Int. Cl. G06F 11/07; G06F 9/48

(52) U.S. Cl. CPC G06F 11/0793; G06F 9/4881; G06F 11/0721

(57) ABSTRACT

Various embodiments of systems and methods to provide continual execution in a computing system are described herein. In one aspect, an unfinished process flow instance is retrieved. The unfinished process flow instance is persisted in a data repository during execution of a process flow instance. One or more steps having a failed execution status are identified in an unfinished process flow instance. Further, at least one failure recovery action associated with the identified one or more steps are performed for successful execution of the one or more steps. The failed execution status of the one or more steps is modified with successful execution. The successful execution of the unfinished process flow instance is notified to a user.

### FIELD

Embodiments generally relate to computer systems and more particularly to methods and systems to provide continual execution in a computing system.

### BACKGROUND

With the increasing deployment of cloud based services, web based applications, software as a service, service oriented architectures, and so forth, the locations of services and applications are crossing physical, jurisdictional, and security boundaries. Process flows associated with applications, for example in a cloud environment, depend on heterogeneous combinations of systems, hardware platforms, remote servers, network protocols, management tools, and so on. Further, as the scale of computing increases, steps involved in the process flows of configuration, setup of constraints/policies on usage, governance of cloud applications, and infrastructure management are automated. Thereby, the process flows may include automated steps and multiple dependencies.

During execution of process flows, steps may fail due to different reasons such as environment reasons, failure of remote servers, failure of dependent systems, and so on. When the execution of a process flow fails, data corresponding to partial execution may be rolled back. After few attempts to execute the process flow, users may tend to lose interest. Also, a user requesting to re-execute the process flow before completion of the initial request may increase work load on the system.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an example of a system in which an environment described herein may be implemented, according to an embodiment.

FIG. 2 is a flow diagram illustrating an example to provide continual execution of a process flow instance, according to an embodiment.

FIG. 3 is a flow diagram illustrating an example process of updating a data repository based on execution of a process flow instance, according to an embodiment.

FIG. 4 is a block diagram illustrating example interactions between different modules for executing a process flow instance, according to an embodiment.

FIG. 5 is a block diagram of an example computing system, according to an embodiment.

### DETAILED DESCRIPTION

Embodiments of techniques to provide continual execution in a computing system are described herein. In the below description, numerous specific details are set forth to provide a thorough understanding of embodiments. One skilled in the relevant art will recognize, however that the embodiments can be practiced without one or more of the specific details or with other methods, components, techniques, etc. In other instance, well-known operations or structures are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. Situation where upon completion of the first step, a second step is executed. Such a situation will be specifically pointed out when not clear from the context. A particular step may be omitted. A particular step is required only when its omission would materially impact another step.

In this document, various computer-implemented methods, processes and procedures are described. It is to be understood that the various actions (determining, identifying, notifying, storing, retrieving, etc.) are performed by a hardware device (e.g., computing system), even if the action may be authorized, initiated or triggered by a user, or even if the hardware device is controlled by a computer program, software, firmware, and the like. Further, it is to be understood that the hardware device is operating on data, even if the data may represent concepts or real-world objects, thus the explicit labeling as “data” as such is omitted.

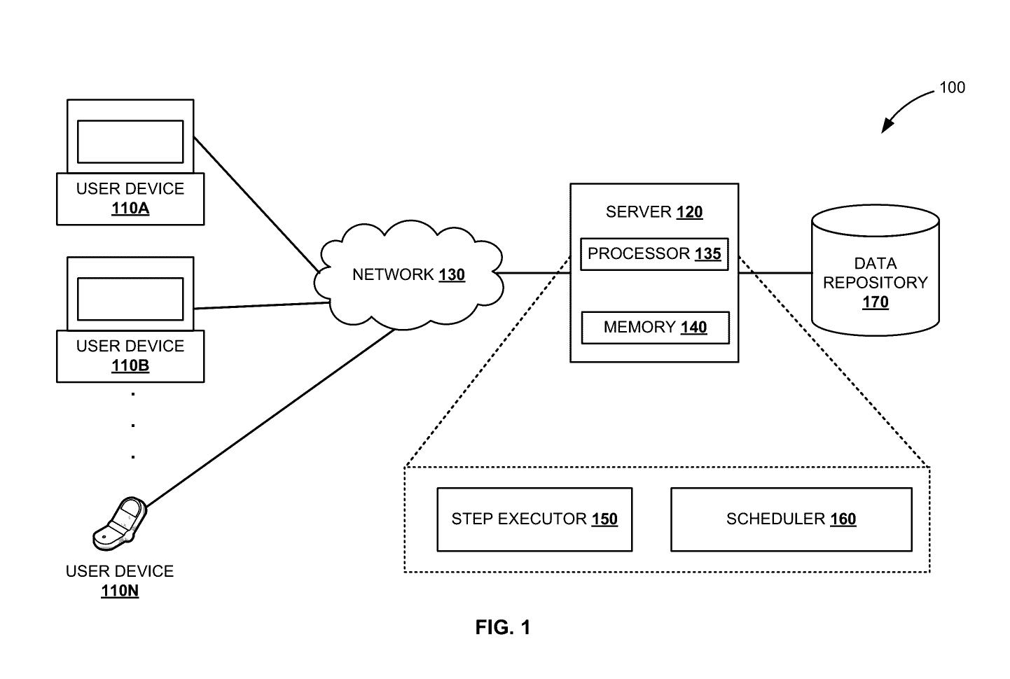

FIG. 1 is a block diagram illustrating an example of system 100 in which an environment described herein may be implemented, according to an embodiment. The system 100 includes one or more front-end components (e.g., user devices 110A to 110N) and a back-end component (e.g., server 120). Network 130 allows the front-end components (e.g., the user systems 110A to 110N) and the back-end component (e.g., server 120) to communicate and exchange data. The network 130 may include a high-speed data link, such as Ethernet, that connects the user systems 110A to 110N to the server 120. The connection may be wired or wireless. A user device (e.g., the user devices 110A to 110N) may be a computing device, such as a desktop computer, a laptop computer, a mainframe computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices, that is capable of requesting the server 120 for accessing an application.

The server 120 may be any type of computing system that is capable of receiving, processing and storing data, and of communicating with the user devices 110A to 110N. As shown in FIG. 1, the server 120 includes one or more processors (referred as “processor 135”) and memory 140 that stores computer programs that are executable by the processor 135. Further, the processor 135 or “CPU” is in electronic communication with a non-transitory computer-readable storage medium through a high speed memory bus, for instance. In one exemplary embodiment, the computer-readable storage medium is stored thereon code. Further, the code may be configured to reference data stored in a database of the non-transitory computer-readable storage medium, for example as may be present locally or in a remote database server. Software servers together may form a cluster or logical network of computer systems programmed with software programs that communicate with each other and work together in order to process requests.

The processor 135 executes the instructions stored in the memory 140 by accessing relevant data stored in data repository 170. In one embodiment, the server 120 includes step executor 150 and scheduler 160, which can be modules of computer program instructions to execute applications requested by users from the user devices 110A to 110N. The step executor 150 and the scheduler 160 may, depending upon the implementation, be part of an application, another application, and a module of the server 120 or another computing system. For example, the step executor 150 and the scheduler 160 can be implemented on a computing system such as a desktop computer, personal computer, tablet, cell phone or other mobile device, to execute the applications. Further, the scheduler 160 can be part of the step executor 150, for instance.

An application is a set of computer programs designed to permit the user devices 110A to 110N to perform a group of coordinated functions, tasks, or activities. Further, the application can be a cloud application, an application program that functions in the cloud, with some characteristics of a desktop application and some characteristics of a Web application. The desktop application resides on a user device (e.g., user devices 110A to 110N) and the Web application is stored on one or more remote servers and is delivered over the Internet through a browser interface. In one exemplary embodiment, the application includes a process flow having multiple steps depending on different systems.

In one embodiment, when a request to access the application is received by the step executor 150 from a user device (e.g., user device 110A), a process flow instance corresponding to the user is generated. The process flow instance includes data for executing the steps. For example, consider a registration process in a SuccessFactors)'s “Onboarding” application. Registration can be defined as a process where a developer implements interfaces of the registration process, including multiple steps and data for executing the steps. The steps may include creating user (data: registering user in a registry), creating an account for the user (data: created credentials from previous step), subscribing new account for an application set (data: account identifier (ID), user ID), notifying user about successful onboarding (data: user ID, account details (e.g., name, description, message, link to account)). Further, the step executor 150 executes the process flow instance step by step. Upon successful execution of the process flow instance, the user device 110A is notified of successful execution and the data repository 170 is updated with successful execution.

When one or more steps of the process flow instance are failed, the step executor 150 updates the data repository 170 with failed execution statuses and failure recovery actions associated with the failed steps. The failure recovery actions are configured based on the successfully executed steps and steps required for successful execution of the failed steps. A failure recovery action can be, but not limited to retrying a failed step for a number of times based on pre-defined intervals and executing helper steps mapped to the failed step. In other words, the step executor 150 identifies an error or a reason for failure. According to the error, the step executor 150 decides the failure recovery actions for successful execution of the failed step (e.g., whether to retry the failed step or retrigger the process flow instance or execute the helper step). Further, the user is notified about failure in executing the request and the request will be successfully processed shortly. Thereby, receiving same request multiple times from the user can be avoided.

In one embodiment, the scheduler 160 is triggered. For example, the scheduler 160 is triggered periodically (e.g., at regular intervals) or whenever an unfinished process flow instance is persisted in the data repository 170. When the scheduler 160 is triggered, the scheduler 160 examines the unfinished flow instances in the data repository 170 by retrieving the unfinished flow instances from the step executor 150. For a particular unfinished flow instance, the scheduler 160 identifies steps which are failed. The process flow instance may fail at different stages. There are chances that a first step of the process flow instance may be failed or a last step of the process flow instance may be failed or any intermediate steps may be failed. Further, based on the failure recovery actions associated with the failed steps, a decision is made by the scheduler 160 to retrigger the process flow instance or retry to execute the failed step or execute a step helper.

For example, when the first step is failed, the failure recovery action includes executing the process flow instance again. When first few steps are successfully completed and then a step is failed, the failure recovery action can include re-executing the process flow instance from the failed step. When the failed step is dependent on another step (e.g., step helper), the failure recovery action can be executing the step helper prior to executing the failed step. Therefore, the failed steps in the process flow instance are continual executed or retriggered for successful execution of the process flow instance. When all steps of the process flow instance are successfully finished, a success action of process flow instance is triggered. The success action can be, but not limited to sending an e-mail notification, and application notification to the user device. Thereby, when the process flow instance is unfinished in the environment or a system, the process flow instance is persisted and continually executed until the process flow instance is successfully executed.

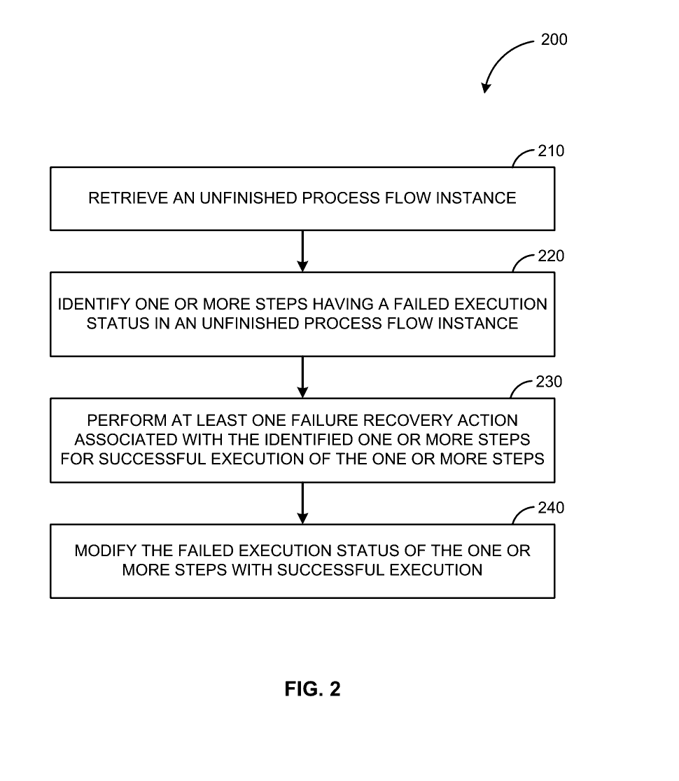

FIG. 2 is a flow diagram illustrating example process 200 to provide continual execution of a process flow instance, according to an embodiment. The process 200 can be implemented for applications in cloud environment, which enables ubiquitous network access to a shared pool of configurable computing resources. The applications may include processes having multiple steps, which are dependent on, but are not limited to remote services, host switches, tenants and security management. One example of such an application is SuccessFactors, “Onboarding” application. Onboarding application provides user to step up an account in cloud to access various applications. For example, the Onboarding application provides step-by-step wizards walk hiring managers through the process of how to prepare for the new hire, and an easy-to-use dashboard makes it simple to track progress along the way. Thereby, the Onboarding application depends on multiple systems, remote services and the like.

In one embodiment, when a request is received to access the application, a process flow instance for the received request is generated. The process flow instance includes multiple steps (e.g., step 1 to step N) and code of one success action corresponding to a user from whom the request is received. Further, a step executor executes the steps associated with the process flow instance. A step can be defined as an executed code unit, execution of the step can be determined as success or failure. In one instance, when the steps are executed successfully, the success action is triggered. The success action can be notifying a user device that the process flow instance is successfully executed by sending an email, a pop-up message, and the like.

In one exemplary embodiment, when execution of one or more steps in the process flow instance is failed, a data repository is updated with the statutes of the failed steps and also failure recovery actions corresponding to the failed steps are configured. The failure recovery actions are configured based on the successfully executed steps and steps required for successful execution of the failed steps. A failure recovery action can be, but not limited to retrying the identified steps for a number of times based on pre-defined intervals and executing helper steps mapped to the identified steps. A step helper can be defined as an additional step that may be executed in case a step is failed and help the step to succeed on next execution. In one exemplary embodiment, every failed step in the unfinished process flow instance includes a failure recovery action. In other words, the data repository includes information of execution statues of the failed steps and corresponding failure recovery actions. Further, the user device is notified regarding failure in the execution of the process flow instance based at what stage the process flow instance is failed. For example, when a first step of the process flow instance is failed, the user device is notified that the process flow instance will be retriggered shortly. When an intermediate step of the process flow instance is failed, the user device is notified that the process flow instance will be finished shortly. When the step of the process flow instance is failed because a password provided by the user is wrong, the user device is notified to provide correct password.

In one embodiment, a scheduler will be triggered. In one example, the scheduler will be triggered at a pre-determined time interval. In another example, the scheduler will be trigged upon occurrence of an unfinished process flow instance. At 210, an unfinished process flow instance is retrieved when the scheduler is triggered. The unfinished process flow instance is persisted in a data repository during execution of the process flow instance. For example, when a registration process in the onboarding application is unfinished or failed for the user, status of the process flow instance associated with the registration process corresponding to the user is stored in the data repository. Similarly, the data repository may include statuses of multiple process flow instances.

At 220, one or more steps having failed execution status in the unfinished process flow instance are identified. For example, consider the registration process includes five steps. Execution statuses of the five steps as stored in the data repository are scrutinized to identify steps having failed execution status. In the example, when one to three steps of the registration process are executed successfully and the last two steps are failed, the last two steps are identified by the scheduler.

At 230, at least one failure recovery action is performed associated with the identified one or more steps for successful execution of the one or more steps. In one exemplary embodiment, the failure recovery action is configured based on successfully executed one or more steps and the identified one or more steps upon executing the process flow instance. Further, the failure recovery action associated with the identified steps are configured when the status are stored in the data repository by the step executor. The failure recovery action can be, but not limited to retrying the step for a number of times corresponding to the retry period, and executing the step helper mapped to the failed step.

In one exemplary embodiment, the scheduler considers a failed step in the process flow instance and performs failure recovery action associated with the failed step. In the example, the fourth step of the registration process is failed, thereby the failure recovery action (e.g., step helper “trigger step X”) associated with the fourth step is performed. Accordingly, the fourth step in the registration process is executed. Further, the fifth step is executed. Therefore, the process flow instance is successfully executed.

In one exemplary embodiment, when the scheduler fails to execute the failed steps, the failure recovery actions associated with the failed steps are updated. Further, the scheduler tries to execute the failed step when the scheduler is triggered for next time. In the example, upon successfully executed the failed fourth step, if the fifth step is failed, the data repository is updated that the fifth step is failed and also the failure recovery action (e.g., retry after two seconds) associated the fifth step. Further, when the scheduler is trigged after a predetermined time period, the scheduler executes the fifth step based on the failure recovery action. Thereby, the scheduler continually executes the process flow instance until the steps are successfully executed and the data related to executing the process flow instance are persisted until the steps are successfully executed.

At 240, the failed execution status of the one or more steps is modified with successful execution. Further, the step executor is notified with the successful execution of the process flow instance. The step executor triggers a success action of the unfinished process flow instance to notify the user about successful execution.

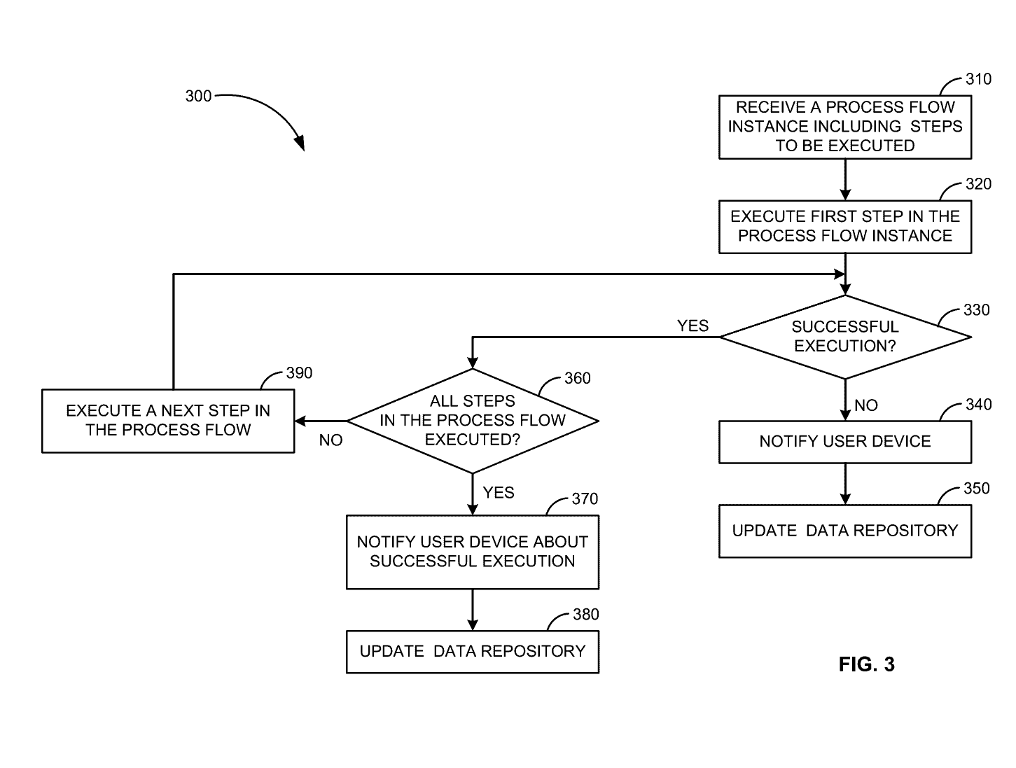

FIG. 3 is a flow diagram illustrating example process 300 of updating a data repository based on execution of a process flow instance, according to an embodiment. At 310, the process flow instance including steps to be executed is received. When a request to access an application is received, the process flow instance is generated. The process flow instance may include multiple steps required to execute the application corresponding to a user from whom the request is received.

At 320, a first step of the process flow instance is executed. Further, a check is made to determine whether the first step is successfully executed, at 330. At 340, when the execution of the first step is failed, a user device from which the request to access the application is received is notified that the process flow instance is unfinished and will complete the process flow instance shortly, for instance. However, a developer of the application may decide on whether to notify the user device depending on the application. At 350, a data repository is updated with execution status of the first step and a failure recovery action associated with the first step (e.g., retries after a predetermined time period or execute step X before executing the first step).

When the execution of the first step is successful, a check is made to determine whether all steps in the process flow instance are executed, at 360. At 370, when the steps of the process flow instance are successfully executed, the user device is notified with successful execution, for instance. However, the developer of the application may decide on whether to notify the user device depending on the application. Further, the data repository is updated with successful execution, at 380. When there are steps in the process flow instance to be executed after first step, a next step in the process flow instance is executed, at 390. Further, the steps described at 330 to 380 are performed.

In one embodiment, a type of the process flow instance is monitored to avoid executing a type of process flow instance request again when first request having same type of process flow instance is failed. The type of the unfinished process flow instance is identified. Further, new requests corresponding to the type of the unfinished process flow instance for execution is queued. The queued new request is executed upon the successful execution of the unfinished process flow instance. For example, when a process flow instance (e.g., registration process) corresponding to a first user is failed and if a second user also requests for the registration process, the request of the second user is kept in queue until the registration process of the first user is successful. Thereby avoiding executing a step upon having knowledge that the step execution may be failed.

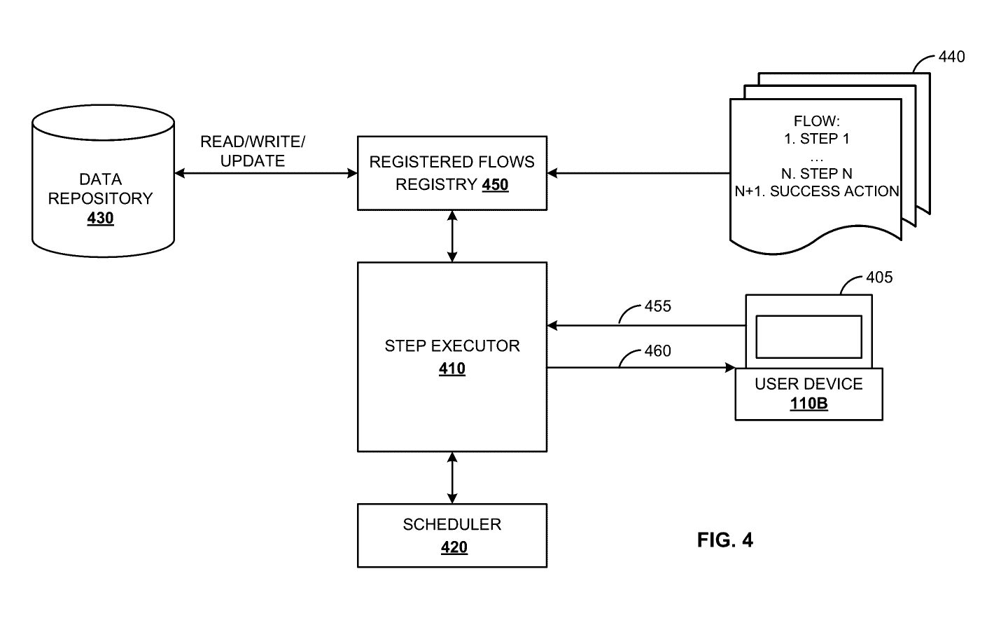

FIG. 4 is a block diagram illustrating example interactions between different modules for executing a process flow instance, according to an embodiment. The process represents the interactions and the operations involved between step executor 410, scheduler 420 and data repository 430. When a request to access an application is received from a user (e.g., user system 455), a flow interface associated with steps involved in the flow to execute the request is implemented and registered in registered flows registry 450. The flow interface is a template depicting the steps (e.g., step 1 to step n) followed to execute the request, shown as 440. Further, a process flow instance having the necessary and updated data for steps execution associated with the user is generated.

Further, the step executor 410 executes the process flow instance step by step. Upon successful execution of the process flow instance, the user system 405 is notified of successful execution and the data repository 430 is updated with successful execution. When one or more steps of the process flow instance are failed, the step executor 410 updates the data repository 430 with failed execution statuses and failure recovery actions associated with the failed steps. The failure recovery actions include steps to be performed for successful execution of failed steps.

In one embodiment, the scheduler 420 is triggered. When the scheduler 420 is triggered, the scheduler 420 examines unfinished flow instances in the data repository 430 by retrieving the unfinished flow instances from the step executor 410. For a particular unfinished flow instance, the scheduler 420 identifies steps that are failed. Further, the scheduler 420 executes failed steps for successful execution of the process flow instance based on associated failure recovery actions. In one exemplary embodiment, when the scheduler 420 is part of the step executor 410, the scheduler 420 is triggered to identify the failed steps. Further, the failed steps are executed by the step executor 410. Therefore, the unfinished process flow instances are persisted and continually executed until the process flow instance is successfully executed. Upon successful execution of the process flow instance, the user system 405 is notified with successful execution, shown as 460.

The process described above is not limited to embodiments that solve any disadvantages or that operate only in environments such as those described above. Further, the above described process for achieving a successful execution of process flow instances can be extended for other scenarios such as user interface (UI) wizard. In the UI wizard, wizard pages can be defined as steps. Further, request for the wizard pages can be persisted and in case of crisis, the failed step is retried automatically until the request is succeeded by the scheduler. Further, the user is notified that step is completed successfully and the user can continue the wizard from a next step.

Some embodiments may include the above-described methods being written as one or more software components. These components, and the functionality associated with them, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computing system that is remotely located from a second computing system containing an interface level (e.g., a graphical user interface). These first and second computing systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computing system which causes the computing system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape: optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

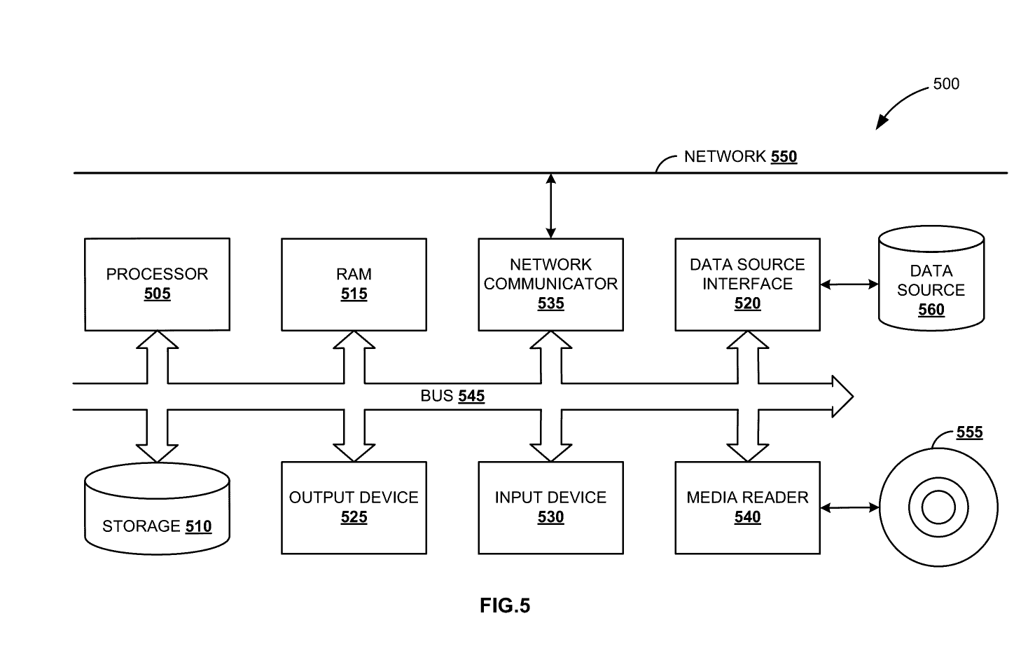

FIG. 5 is a block diagram of example computing system 500, according to an embodiment. The computing system 500 includes a processor 505 that executes software instructions or code stored on a computer readable storage medium 555 to perform the above-illustrated methods. The processor 505 can include a plurality of cores. The computing system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. According to some embodiments, such as some in-memory computing system embodiments, the RAM 515 can have sufficient storage capacity to store much of the data required for processing in the RAM 515 instead of in the storage 510. In some embodiments, the data required for processing may be stored in the RAM 515. The stored instructions may be further compiled to generate other representations of the instructions and dynamically stored in the RAM 515. The processor 505 reads instructions from the RAM 515 and performs actions as instructed. According to one embodiment, the computing system 500 further includes an output device 525 (e.g., a display) to provide at least some of the results of the execution as output including, but not limited to, visual information to users and an input device 530 to provide a user or another device with means for entering data and/or otherwise interact with the computing system 500. One or more of these output devices 525 and input devices 530 could be joined by one or more additional peripherals to further expand the capabilities of the computing system 500. A network communicator 535 may be provided to connect the computing system 500 to a network 550 and in turn to other devices connected to the network 550 including other clients, servers, data stores, and interfaces, for instance. The modules of the computing system 500 are interconnected via a bus 545. Computing system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiments are described herein for illustrative purposes, various equivalent modifications are possible within the scope of the embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium storing instructions, which when executed by a computer cause the computer to:
retrieve an unfinished process flow instance, wherein the unfinished process flow instance is persisted in a data repository during execution of a process flow instance:
identify one or more steps having a failed execution status in an unfinished process flow instance;
perform at least one failure recovery action associated with the identified one or more steps for successful execution of the one or more steps, wherein the at least one failure recovery action is configured based on successfully executed one or more steps and the identified one or more steps upon executing the process flow instance; and
modify the failed execution status of the one or more steps with successful execution.

2. The non-transitory computer-readable medium of claim 1, further comprising instructions, which when executed by the computer cause the computer to notify the successful execution of the unfinished process flow instance.

3. The non-transitory computer-readable medium of claim 1, wherein the at least one failure recovery action comprises retrying the identified one or more steps for a number of times based on pre-defined intervals.

4. The non-transitory computer-readable medium of claim 1, wherein the at least one failure recovery action comprises executing helper steps mapped to the identified one or more steps.

5. The non-transitory computer-readable medium of claim 1, wherein executing the process flow instance further comprising:
identifying a type of the unfinished process flow instance;
queueing new requests corresponding to the type of the unfinished process flow instance for execution; and
executing the queued new request upon the successful execution of the unfinished process flow instance.

6. The non-transitory computer-readable medium of claim 1, wherein the unfinished process flow instance is retrieved by a scheduler upon receiving a trigger to determine unfinished flow instances in the data repository.

7. The non-transitory computer-readable medium of claim 1, further comprising instructions, which when executed by the computer cause the computer to: update the at least one failure recovery action associated with the identified one or more steps when execution of the identified one or more steps is unsuccessful by a scheduler.

8. A computer implemented method to provide continual execution of a process flow instance, comprising:
retrieving an unfinished process flow instance, wherein the unfinished process flow instance is persisted in a data repository during execution of the process flow instance;
identifying one or more steps having a failed execution status in an unfinished process flow instance;
performing at least one failure recovery action associated with the identified one or more steps for successful execution of the one or more steps, wherein the at least one failure recovery action is configured based on successfully executed one or more steps and the identified one or more steps upon executing the process flow instance; and
modifying the failed execution status of the one or more steps with successful execution.

9. The computer implemented method of claim 8, further comprising notifying the successful execution of the unfinished process flow instance.

10. The computer implemented method of claim 8, wherein the at least one failure recovery action comprises retrying the identified one or more steps for a number of times based on pre-defined intervals.

11. The computer implemented method of claim 8, wherein the at least one failure recovery action comprises executing helper steps mapped to the identified one or more steps.

12. The computer implemented method of claim 12, further comprising:
identifying a type of the unfinished process flow instance:
queueing new requests corresponding to the type of the unfinished process flow instance for execution; and
executing the queued new request upon the successful execution of the unfinished process flow instance.

13. The computer implemented method of claim 8, wherein the unfinished process flow instance is retrieved by a scheduler upon receiving a trigger to determine unfinished flow instances in the data repository.

14. The computer implemented method of claim 8, further comprising: updating the at least one failure recovery action associated with the identified one or more steps when execution of the identified one or more steps is unsuccessful by a scheduler.

15. A computing system to provide continual execution of process flow instances, comprising:
at least one processor; and
one or more memory devices communicative with the at least one processor, wherein the one or more memory devices store instructions to:
retrieve an unfinished process flow instance, wherein the unfinished process flow instance is persisted in a data repository during execution of the process flow instance;
identify one or more steps having a failed execution status in an unfinished process flow instance;
perform at least one failure recovery action associated with the identified one or more steps for successful execution of the one or more steps, wherein the at least one failure recovery action is configured based on successfully executed one or more steps and the identified one or more steps upon executing the process flow instance; and
modify the failed execution status of the one or more steps with successful execution.

16. The computing system of claim 15, further comprising notifying the successful execution of the unfinished process flow instance.

17. The computing system of claim 15, wherein the at least one failure recovery action comprises retrying the identified one or more steps for a number of times based on pre-defined intervals.

18. The computing system of claim 15, wherein the at least one failure recovery action comprises executing helper steps mapped to the identified one or more steps.

19. The computing system of claim 15, wherein the unfinished process flow instance is retrieved by a scheduler upon receiving a trigger to determine unfinished flow instances in the data repository.

20. The computing system of claim 19, further comprising:
identifying a type of the unfinished process flow instance;
queueing new requests corresponding to the type of the unfinished process flow instance for execution; and
execute the queued new request upon the successful execution of the unfinished process flow instance.
